(19) United States
(12) Patent Application Publication
(10) Pub. No.: US 2014/0078442 A1
(43) Pub. Date: Mar. 20, 2014

(54) LIQUID CRYSTAL DISPLAY DEVICE

(71) Applicant: SAMSUNG DISPLAY CO., LTD., Yongin-City (KR)

(72) Inventors: Joo-Yeon WON, Seoul (KR); Sung-Dong PARK, Asan-si (KR); Chong Guk LEE, Seoul (KR); Byung Goo JUNG, Goyang-si (KR)

(73) Assignee: Samsung Display Co., Ltd., Yongin-City (KR)

(21) Appl. No.: 13/748,396

(22) Filed: Jan. 23, 2013

(30) Foreign Application Priority Data
Sep. 20, 2012 (KR) 10-2012-0104552

(51) Int. Cl. G02F 1/133

(52) U.S. Cl. CPC G02F 1/13306
USPC 349/58

(57) ABSTRACT

A liquid crystal display device may include a liquid crystal display panel. The liquid crystal display device may further include a printed circuit board configured to provide control signals for the liquid crystal display panel. The liquid crystal display device may further include a connector configured to electrically connect the printed circuit board with an external device that is external to the liquid crystal display device. The liquid crystal display device may further include a connector support overlapping the connector. A portion of the printed circuit board may overlap the connector and may be disposed between the connector and the connector support.

### CROSS-REFERENCE TO RELATED APPLICATION

This application claims priority to and the benefit of Korean Patent Application No. 10-2012-0104552 filed in the Korean Intellectual Property Office on Sep. 20, 2012, the entire contents of which are incorporated herein by reference.

### BACKGROUND OF THE INVENTION

(a) Field of the Invention

The present invention relates to a liquid crystal display (i.e., liquid crystal display device).

(b) Description of the Related Art

The liquid crystal display, which is one of the most common types of flat panel displays currently in use, typically includes a liquid crystal panel and a light source. The liquid crystal panel may include field generating electrodes (such as a pixel electrode and a common electrode) and a liquid crystal layer interposed between the field generating electrodes.

The liquid crystal display may generate an electric field in the liquid crystal layer by applying voltage to the field generating electrodes. The liquid crystal display may determine the direction(s) of liquid crystal molecules of the liquid crystal layer using the generated electric field, thereby controlling polarization of incident light provided by the light source, so as to control displayed images.

In order to control the liquid crystal panel and the light source, a printed circuit board (PCB) for applying one or more driving signals may be used. The printed circuit board may be disposed in a bezel of the liquid crystal display that surrounds a display area of the liquid crystal display and may be connected to an external device through a connector.

Slimness of the bezel of the liquid crystal display has been desired. In order to reduce the width of the bezel of the liquid crystal display, the connector may overlap the printed circuit board and may be fastened to the printed circuit board in a direction perpendicular to a top surface or a bottom surface of the printed circuit board. During the fastening, deformation (such as bending) of the printed circuit board may occur (due to pressure on the printed circuit board) and may cause damage to the printed circuit board.

The above information disclosed in this Background section is only for enhancement of understanding of the background of the invention. The Background section may contain information that does not form the prior art that is already known in this country to a person of ordinary skill in the art.

### SUMMARY OF THE INVENTION

Embodiments of the present invention may minimize deformation of a printed circuit board of a liquid crystal display device and/or may minimize a dimension (e.g., a width) of a bezel of the liquid crystal display device.

One or more embodiments of the invention may be related to a liquid crystal display device that may include a liquid crystal display panel. The liquid crystal display device may further include a printed circuit board configured to provide control signals for the liquid crystal display panel. The liquid crystal display device may further include a connector configured to electrically connect the printed circuit board with an external device that is external to the liquid crystal display device. The liquid crystal display device may further include a connector support overlapping the connector. A portion of the printed circuit board may overlap the connector and may be disposed between the connector and the connector support.

In one or more embodiments, the liquid crystal display device may further include a backlight assembly configured to provide light to the liquid crystal panel. The liquid crystal display device may further include a chassis containing a least a portion of the backlight assembly. A surface of the connector support may contact the printed circuit board and overlaps the connector.

In one or more embodiments, the connector support extends from the chassis, and the chassis and the connector support are made of a same material.

In one or more embodiments, the connector support is spaced from the chassis and is an electrical insulator.

In one or more embodiments, the printed circuit board completely overlaps the connector support.

In one or more embodiments, the connector support completely overlaps the connector.

In one or more embodiments, the liquid crystal display device may further include a first printed circuit board support and a second printed circuit board support that overlap the printed circuit board and are configured to support the printed circuit.

In one or more embodiments, the connector support is disposed between the first printed circuit board support and the second printed circuit board support.

In one or more embodiments, the liquid crystal display device may include a backlight assembly configured to provide light to the liquid crystal panel and may include a chassis configured to support the backlight assembly. The first printed circuit board supports extends from the chassis. The chassis and the first printed circuit board support are made of a same material.

In one or more embodiments, the connector support extends from the chassis and is longer than the first printed circuit board support.

In one or more embodiments, the connector support extends from the chassis and extends in parallel to the first printed circuit board support.

In one or more embodiments, the liquid crystal display device may include a first coupling member disposed through at least one of the printed circuit board and the first printed circuit board support for coupling the printed circuit board with the first printed circuit board support.

In one or more embodiments, the liquid crystal display device may further include a second coupling member disposed through at least one of the printed circuit board and the second printed circuit board support for coupling the printed circuit board with the second printed circuit board support. The connector support may be disposed between the first coupling member and the second coupling member.

In one or more embodiments, a surface of the printed circuit board contacts the connector support, and the first coupling member extends in a direction that is perpendicular to the surface of the printed circuit board.

According to embodiments of the present invention, a connector support for supporting a printed circuit board portion to which a connecter is attached is included in a liquid crystal display, such that deformation (e.g., bending) of a printed circuit board of the liquid crystal display may be prevented and/or minimized. Embodiments of the invention may minimize deformation of the printed circuit board without substantially enlarging the bezel of the liquid crystal display that surrounds a display area of the liquid crystal display.

### BRIEF DESCRIPTION OF THE DRAWINGS

FIG. 1 is a partial layout view (or partial plan view) illustrating a liquid crystal display according to one or more embodiments of the present invention.

FIG. 2 is a cross-sectional view taken along line II-II indicated in FIG. 1.

FIG. 3 is a cross-sectional view taken along line III-III indicated in FIG. 1.

FIG. 4 is a partial cross-sectional view illustrating a liquid crystal display according to one or more embodiments of the present invention.

### DETAILED DESCRIPTION OF THE EMBODIMENTS

Hereinafter, embodiments of the present invention will be described in detail with reference to the accompanying drawings. As those skilled in the art would realize, the described embodiments may be modified in various different ways, all without departing from the spirit or scope of the present invention.

In the drawings, the thickness of layers, films, panels, regions, etc., may be exaggerated for clarity. It will be understood that when a layer is referred to as being “on” another layer or substrate, it can be directly on the other layer or an intervening element may also be present. Like reference numerals may designate like elements throughout the specification.

Although the terms first, second, third etc. may be used herein to describe various signals, elements, components, regions, layers, and/or sections, these signals, elements, components, regions, layers, and/or sections should not be limited by these terms. These terms may be used to distinguish one signal, element, component, region, layer, or section from another signal, region, layer or section. Thus, a first signal, element, component, region, layer, or section discussed below may be termed a second signal, element, component, region, layer, or section without departing from the teachings of the present invention. The description of an element as a “first” element may not require or imply the presence of a second element or other elements. The terms first, second, third etc. may also be used herein to differentiate different categories of elements. For conciseness, the terms first, second, third, etc. may represent first-category, second-category, third-category, etc., respectively.

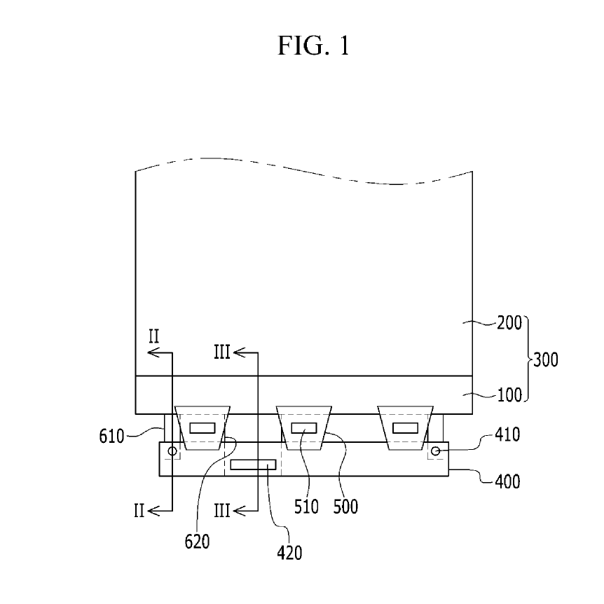

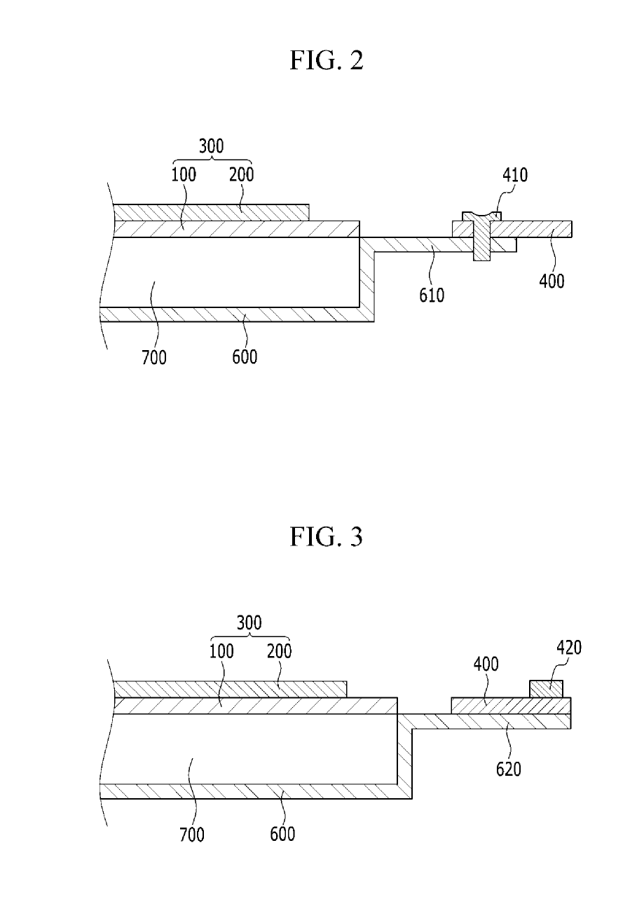

FIG. 1 is a partial layout view (or partial plan view) of a liquid crystal display according to one or more embodiments of the present invention, FIG. 2 is a cross-sectional view taken along line II-II indicated in FIG. 1, and FIG. 3 is a cross-sectional view taken along line III-III indicated in FIG. 1.

The structures of a liquid crystal display illustrated in FIGS. 1 to 3 may illustrate example features of the present invention, and the present invention is not limited thereto. The liquid crystal display may include one or more of other structures.

Referring to FIGS. 1 to 3, the liquid crystal display may include a liquid crystal panel 300 for displaying images, a backlight assembly 700 for supplying light to the liquid crystal panel 300, and a chassis 600 for containing at least a portion of the backlight assembly 700 and/or for supporting the backlight assembly 700.

The liquid crystal panel 300 includes a thin film transistor array panel 100 that includes a plurality of thin film transistors, a color filter display panel 200 that overlaps the thin film transistor array panel 100, and a liquid crystal layer (not illustrated) disposed between the panels 100 and 200.

In the thin film transistor array panel 100, thin film transistors are disposed on an insulation substrate (such as a transparent glass substrate). A data line is electrically connected to a source terminal of at least a thin film transistor of the thin film transistors, a gate line is electrically connected to a gate terminal of the thin film transistor, and a pixel electrode made of transparent conductive material, such as indium tin oxide (ITO) or indium zinc oxide (IZO), is extended from and/or is electrically connected to a drain terminal of the thin film transistor.

In the color filter display panel 200, a plurality of color filters (including one or more of a red filter, a green filter, a blue filter, a yellow filter, a cyan filter, and a magenta filter) may be disposed on an insulation substrate (such as a transparent glass substrate), and a common electrode made of ITO or IZO may be coated on the color filters and/or the insulation substrate.

When a gate driving signal (e.g., a gate-on voltage) is applied to the gate terminal of the thin film transistor, the thin film transistor is turned on to enable supply of a data signal; as a result, an electric field is formed between the pixel electrode and the common electrode. An alignment angle of liquid crystal molecules is the liquid crystal layer is controlled by the electric field, and light transmittance of the liquid crystal layer is controlled according to the alignment angle. Accordingly, a desired image may be displayed.

The backlight assembly 700 may include a light source for supplying light, a light guide plate for guiding light emitted from the light source to the liquid crystal panel 300, and an optical sheet for ensuring desirable luminance characteristics of the light provided to the liquid crystal panel 300.

The liquid crystal display may further include a printed circuit board 400 for receiving an image signal from an external device. According to the image signal, the printed circuit board may provide driving signals (or control signals) to one or more of the data line, the gate line, and an IC (integrated circuit) chip 510 disposed on a chip mounting film 500, wherein the chip mounting film 500 may be connected between the printed circuit board 400 and the liquid crystal panel 300 The printed circuit board 400 may generate a data signal, a gate driving signal, and a plurality of timing signals for controlling timing of the data signal and the gate driving signal. The IC chip 510 may apply the gate driving signal and the data signal to the gate line and the data line of the liquid crystal panel 300 through the chip mounting film 500.

The printed circuit board 400 is positioned on one or more print circuit board supports 610 (or supports 610) extending from the chassis 600 and is supported by the one or more supports 610. The printed circuit may be coupled to (and fastened to) a support 610 by one or more coupling members 410. In one or more embodiments, the printed circuit board 400 has a rectangular shape having a pair of long sides and a pair of short sides, a first support 610 and a first coupling member 410 may be positioned at a first edge of a first long side of the printed circuit board 400 near a first short side of the printed circuit board 400, and a second support 610 and a second coupling member 410 may be positioned at a second edge of the first long side of the printed circuit board 400 near a second short side of the printed circuit board 400.

A connector 420 for (electrically) connecting the printed circuit board 400 to an external device is disposed (and attached) on the printed circuit board 400. The connector 420 may be completely overlapped (and/or covered) by the printed circuit board 400 without extending beyond the printed circuit board 400 in the plan view of the liquid crystal display, such that the width of the bezel of the liquid crystal display may be minimized.

The printed circuit board 400 portion to which the connecter 420 is attached is positioned on and/or overlaps a connecter support 620 to be supported by the connecter support 620. The connecter support 620 extends from the chassis 600 without extending beyond a second long side of the printed circuit board 400, such that the connector support 620 may not require increase of the width of the bezel of the liquid crystal display. The connecter support 620 (completely) overlaps the connector 420. An edge of the connector support 620 may be aligned with the second long side of the printed circuit board 400. A surface of the connector support 620 may contact the printed circuit board and may overlap the connector 420, wherein the surface of the connector support 620 may be substantially flush with a surface of the backlight assembly such that the thin film transistor panel 100 may be substantially flush with the printed circuit board 400. A side wall of the chassis 600 may be perpendicular to the surface of the connector support 620 and may be disposed between the backlight assembly 700 and the connector support 620. The connector 620 may be disposed between two printed circuit board supports 610.

The connecter support 620 may sufficiently support the printed circuit board 400 portion to which the connecter 420 is attached and may sufficiently reinforce the printed circuit board 400. Advantageously, the connector support 620 may prevent the printed circuit board 400 from deformation and/or bending when the connector 420 is fastened to the printed circuit board 400.

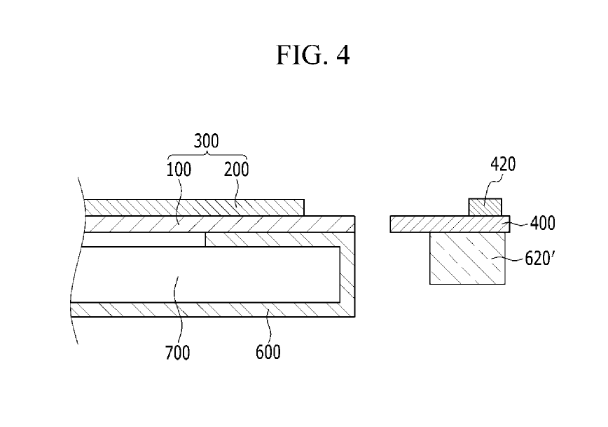

FIG. 4 is a partial cross-sectional view illustrating a liquid crystal display according to one or more embodiments of the present invention.

The liquid crystal display discussed with reference to FIG. 4 may have elements and configurations analogous to elements and configurations of the liquid crystal display discussed with reference to FIG. 1. Description for the analogous elements and configurations may be omitted.

The liquid crystal display discussed with reference to FIG. 4 includes a connector support 620′. The connecter support 620′ is separate from and is spaced from the chassis 600 and may be positioned below the printed circuit board 400 portion to which the connecter 420 is attached to support the connector 420. The printed circuit board 400 portion may be disposed between the connector 420 and the connector support 620′. The printed circuit board 400 may completely overlap (and cover) the connector support 620, such that the connector support 620 may not require increase of the width of the bezel of the liquid crystal display. The connecter support 620 may (completely) overlap the connector 420. The connecter support 620 may be made of an insulator such as acryl.

While this invention has been described in connection with what is presently considered to be practical embodiments, it is to be understood that the invention is not limited to the disclosed embodiments. The invention is intended to cover various modifications and equivalent arrangements included within the spirit and scope of the appended claims.

<Description of symbols>

| | |
|---|---|
| 100: Thin film transistor array panel | 200: Color filter display panel |
| 300: Liquid crystal panel | 410: Coupling member |
| 400: Printed circuit board | 500: Chip mounting film |
| 420: Connector | 610: Printed circuit board support |
| 600: Chassis | 700: Backlight assembly |
| 620, 620′: Connector support | |

What is claimed is:

1. A liquid crystal display device comprising:
a liquid crystal display panel;
a printed circuit board configured to provide control signals for the liquid crystal display panel;
a connector configured to electrically connect the printed circuit board with an external device that is external to the liquid crystal display device; and
a connector support overlapping the connector, wherein a portion of the printed circuit board overlaps the connector and is disposed between the connector and the connector support.

2. The liquid crystal display device of claim 1, further comprising:
a backlight assembly configured to provide light to the liquid crystal panel; and
a chassis containing a least a portion of the backlight assembly,
wherein a surface of the connector support contacts the printed circuit board and overlaps the connector.

3. The liquid crystal display device of claim 2,
wherein the connector support extends from the chassis, and
wherein the chassis and the connector support are made of a same material.

4. The liquid crystal display device of claim 2, wherein the connector support is spaced from the chassis and is an electrical insulator.

5. The liquid crystal display device of claim 1, wherein the printed circuit board completely overlaps the connector support.

6. The liquid crystal display device of claim 1, wherein the connector support completely overlaps the connector.

7. The liquid crystal display device of claim 1, further comprising a first printed circuit board support and a second printed circuit board support that overlap the printed circuit board and are configured to support the printed circuit.

8. The liquid crystal display device of claim 7, wherein the connector support is disposed between the first printed circuit board support and the second printed circuit board support.

9. The liquid crystal display device of claim 7, further comprising:
a backlight assembly configured to provide light to the liquid crystal panel; and
a chassis configured to support the backlight assembly,
wherein the first printed circuit board supports extends from the chassis, and
wherein the chassis and the first printed circuit board support are made of a same material.

10. The liquid crystal display device of claim 9, wherein the connector support extends from the chassis and is longer than the first printed circuit board support.

11. The liquid crystal display device of claim 9, wherein the connector support extends from the chassis and extends in parallel to the first printed circuit board support.

12. The liquid crystal display device of claim 7, further comprising a first coupling member disposed through at least one of the printed circuit board and the first printed circuit board support for coupling the printed circuit board with the first printed circuit board support.

13. The liquid crystal display device of claim 12, further comprising a second coupling member disposed through at least one of the printed circuit board and the second printed circuit board support for coupling the printed circuit board with the second printed circuit board support,
wherein the connector support is disposed between the first coupling member and the second coupling member.

14. The liquid crystal display device of claim 13,
wherein a surface of the printed circuit board contacts the connector support, and
wherein the first coupling member extends in a direction that is perpendicular to the surface of the printed circuit board.
